(19) United States
(12) Patent Application Publication
(10) Pub. No.: US 2005/0093383 A1
(43) Pub. Date: May 5, 2005

(54) Fan motor

(76) Inventors: Wen-Shing Wu, Kaohsiung Hsien (TW); Ren-Jei Wu, Kaohsiung Hsien (TW)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/700,230

(22) Filed: Nov. 3, 2003

(51) Int. Cl. H02K 7/00; F04B 17/00

(52) U.S. Cl. 310/67 R; 310/216; 310/68 B; 417/423.14

(57) ABSTRACT

A fan motor includes base, stator and rotor units. The base unit includes a base plate with a shaft tube extending therefrom. The stator unit includes a stator core member, stator coils, and a circuit board. The stator core member has a metal core body that includes a central hub portion sleeved on the shaft tube, and a plurality of core-winding spokes extending from the central hub portion and having the stator coils wound thereon. The circuit board is coupled electrically to the stator coils. The rotor unit includes a drive shaft mounted rotatably in the shaft tube and extending outwardly of the shaft tube, a sensing ring having an inner ring surface that forms an annular clearance with end faces of the core-winding spokes, and a cover member having the drive shaft extending fixedly therethrough.

### BACKGROUND OF THE INVENTION

1. Field of the Invention

The invention relates to an alternating current motor, more particularly to a fan motor that has a compact and easy to assemble design.

2. Description of the Related Art

Referring to FIG. 1, a conventional fan motor 1 is shown to include a first cover 11, a stator unit 12 disposed in the first cover 11, a second cover 13 secured to the first cover 11, a rotor unit 14 extending into the stator unit 12 and through the second cover 13, and a plurality of screw fasteners 15 to fasten the first and second covers 11, 13 together. The rotor unit 14 includes a drive shaft 142 and a bearing unit 141 for mounting rotatably the drive shaft 142 on the second cover 13. The stator unit 12 includes a stator body 121 and a plurality of stator coil bundles 122. The stator body 121 is coupled to the bearing unit 141, and is formed with a plurality of coil mounting holes, each of which has a coil sleeve 123 made of an insulator material received therein. The stator coil bundles 122 are extended through the coil sleeves 123, either manually or automatically, for mounting the same on the stator body 121. Threads 100 are used to tie together the stator coil bundles 122 for retaining the shape of the same.

When assembling the conventional fan motor 1, after disposing the stator unit 12 in the first cover 11, the drive shaft 142 of the rotor unit 14 is extended through the stator unit 12 and into a central shaft hole 111 in the first cover 11. Then, the second cover 13 is assembled to the rotor unit 14 such that the drive shaft 142 extends through a central shaft hole 131 in the second cover 13. The screw fasteners 15 are subsequently employed to secure the second cover 13 to the first cover 11. Since the first cover 11, the stator unit 12 and the second cover 13 do not have a common base point for engagement, a hammering tool must be used to join together the first cover 11, the second cover 13 and the stator unit 12, thus completing assembly of the conventional fan motor 1.

In use, when an electrical current flows through the stator coil bundles 122, an electromagnetic field is generated for driving rotation of the drive shaft 142 of the rotor unit 14 and a fan blade 10 that is mounted on one end of the drive shaft 142.

The following are some of the drawbacks of the aforesaid conventional fan motor 1:

1. The manufacturing process of the conventional fan motor 1 is rather complicated. To assemble the stator unit 12, the stator body 121 made of silicon steel must be first formed with a plurality of coil mounting holes. Then, each of the coil mounting holes must have a coil sleeve 123 fitted therein. Thereafter, the stator coil bundles 122 must be extended through the coil sleeves 123 for mounting the same on the stator body 121. Finally, the threads 100 are used to tie together the stator coil bundles 122. The production efficiency of the stator unit 12 is accordingly very low.

Moreover, assembly of the conventional fan motor 1 involves engagement operations of the screw fasteners 15, which are rather laborious and not very efficient in terms of production.

2. As described in the foregoing, a hammering operation is necessary since the first cover 11, the stator unit 12 and the second cover 13 do not have a common base point for engagement. As such, when the fan blade 10 rotates, an error in the axial alignment of the bearing unit 141 introduced during the hammering operation can result in the generation of noise when the conventional fan motor 1 operates. Noise can also arise as a result of imbalance among the tightened states of the screw fasteners 15.

3. Since parts of the rotor unit 14, which drives rotation of the fan blade 10, extend into the stator unit 12, the volume of the conventional fan motor 1 is relatively large, thereby resulting in larger space and material requirements during use.

### SUMMARY OF THE INVENTION

Therefore, the object of the present invention is to provide a fan motor that can overcome the aforesaid drawbacks associated with the prior art.

According to the present invention, a fan motor that includes a base unit, a stator unit, and a rotor unit.

The base unit includes a base plate that is formed with a central plate hole, and a shaft tube that extends integrally from the base plate at a periphery of the central plate hole and that is formed with a shaft hole defining a hole axis.

The stator unit includes a stator core member, a plurality of stator coils, and a circuit board. The stator core member has a metal core body that includes a central hub portion and a plurality of core-winding spokes that extend radially, outwardly and integrally from the central hub portion and that are angularly spaced apart from each other. The central hub portion is sleeved on the shaft tube, and defines a sleeve axis coaxial with the hole axis. The metal core body has opposite core surfaces along the sleeve axis. Each of the core-winding spokes extends in a respective radial direction relative to the sleeve axis, and has a peripheral surface that surrounds the respective radial direction. The stator core member further includes an insulator layer coated on the opposite core surfaces of the metal core body and on the peripheral surfaces of the core-winding spokes. Each of the core-winding spokes further has a distal end face remote from the sleeve axis. The stator coils are wound around the insulator layer at the core-winding spokes. The circuit board is disposed adjacent to one of the opposite core surfaces of the metal core body, and is coupled electrically to the stator coils.

The rotor unit includes a drive shaft, a sensing ring, and a cover member. The drive shaft has a base connecting portion extending into the shaft hole and mounted rotatably in the shaft tube of the base unit, and a blade connecting portion extending from the base connecting portion and disposed outwardly of the shaft tube. The sensing ring has an inner ring surface that confines a ring hole coaxial with the hole and sleeve axes. The ring hole has a size sufficient to receive the stator unit therein such that the inner ring surface of the sensing ring forms an annular clearance with the end faces of the core-winding spokes. The cover member has a cover plate portion and a peripheral wall portion extending from a periphery of the cover plate portion. The peripheral wall portion is secured to the sensing ring. The blade connecting portion of the drive shaft extends fixedly through the cover plate portion.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded schematic view of a conventional fan motor;

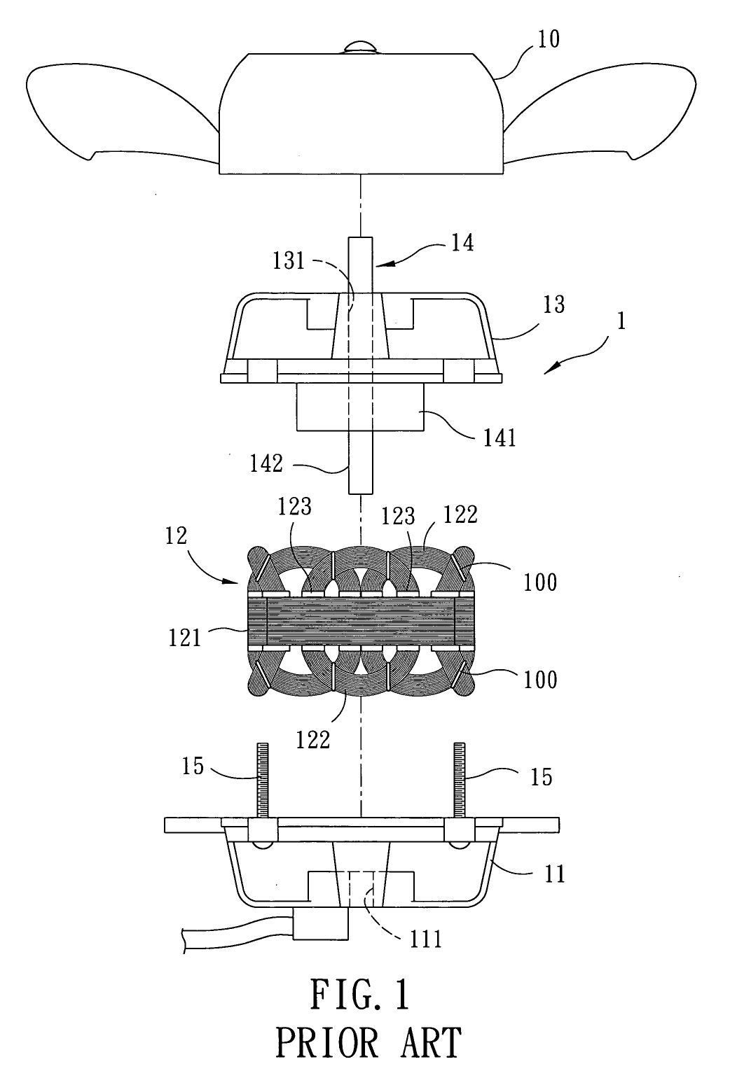

FIG. 2 is an exploded schematic sectional view of the preferred embodiment of a fan motor according to the present invention;

FIG. 3 is an exploded perspective view to illustrate a stator unit and a rotor unit of the preferred embodiment; and

FIG. 4 is an assembled schematic sectional view of the preferred embodiment.

### DETAILED DESCRIPTION OF THE PREFERRED EMBODIMENT

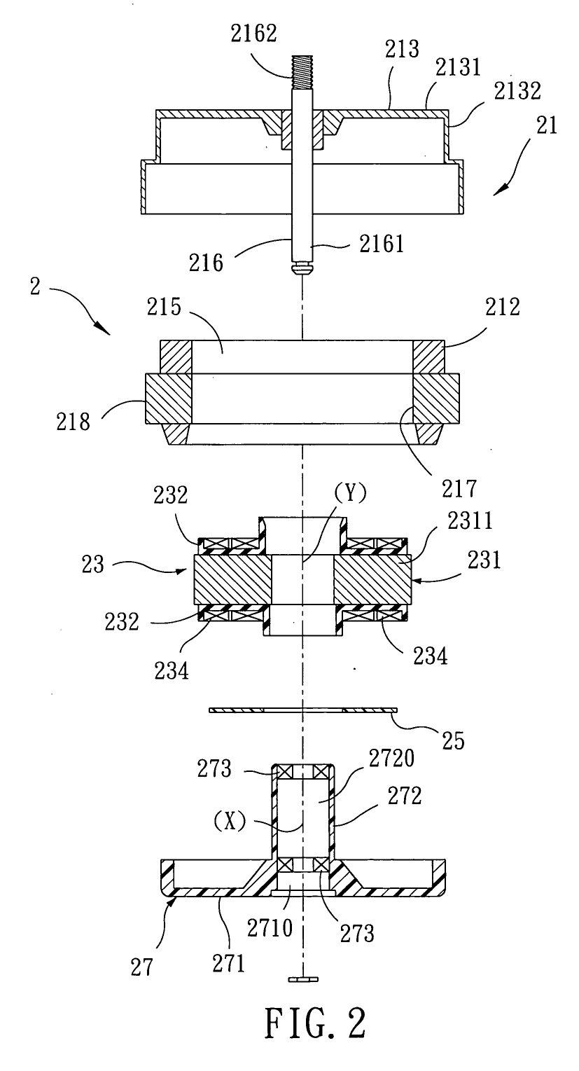

Referring to FIG. 2, the preferred embodiment of a fan motor 2 according to the present invention is shown to include a base unit 27, a stator unit 23, and a rotor unit 21.

The base unit 27 includes a base plate 271 that is formed with a central plate hole 2710, and a shaft tube 272 that extends integrally from the base plate 271 at a periphery of the central plate hole 2710 and that is formed with a shaft hole 2720 defining a hole axis (X).

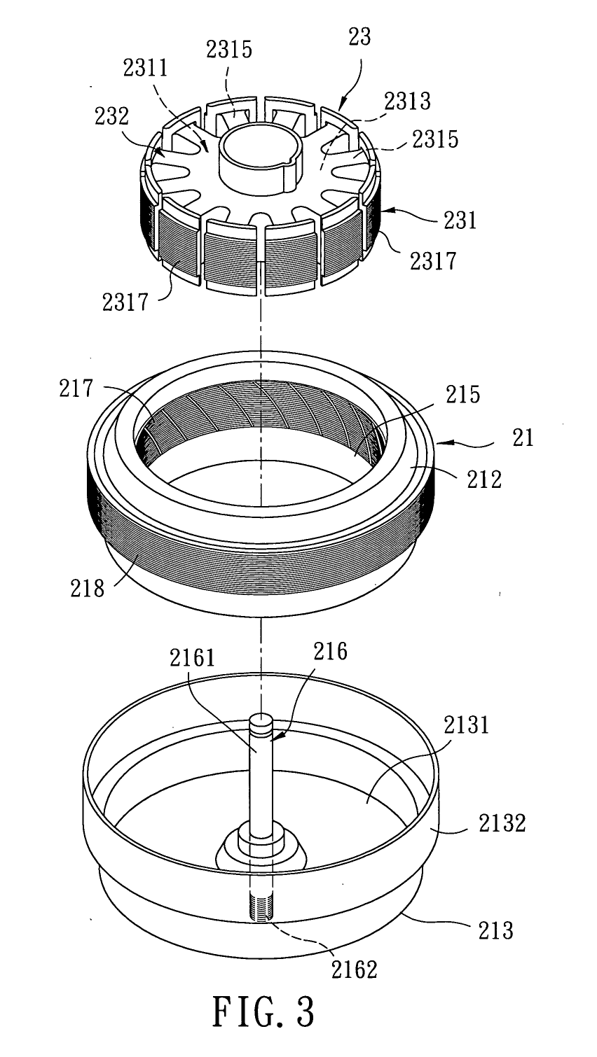

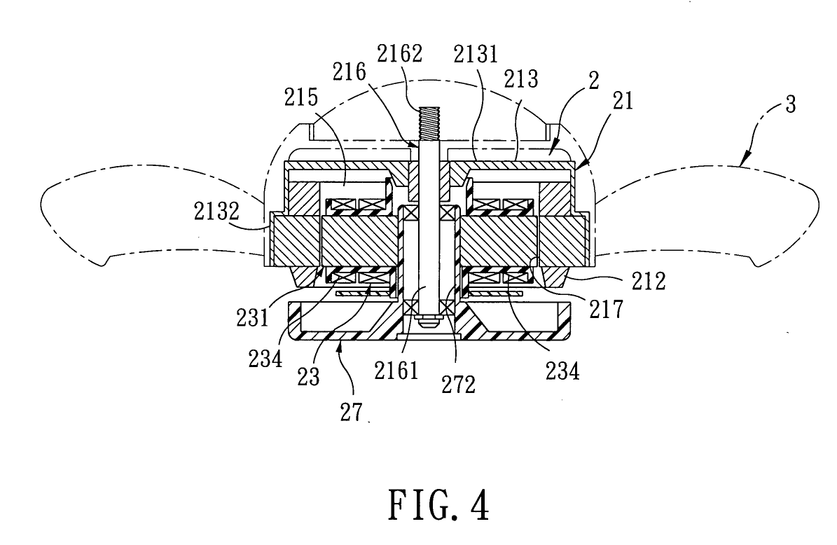

Referring further to FIG. 3, the stator unit 23 includes a stator core member 231, a plurality of stator coils 234, and a circuit board 25. The stator core member 231 has a metal core body 2311 that includes a central hub portion 2313 and a plurality of core-winding spokes 2315 that extend radially, outwardly and integrally from the central hub portion 2313 and that are angularly spaced apart from each other. In this embodiment, the metal core body 2311 is made of silicon steel, and includes twelve of the core-winding spokes 2315, whereby each adjacent pair of the core-winding spokes 2315 forms a 30-degree angle therebetween. The central hub portion 2313 is sleeved on the shaft tube 272 (see FIG. 4), and defines a sleeve axis (Y) coaxial with the hole axis (X). The metal core body 2311 has opposite core surfaces along the sleeve axis (Y). Each of the core-winding spokes 2315 extends in a respective radial direction-relative to the sleeve axis (Y), and has a peripheral surface that surrounds the respective radial direction. The stator core member 231 further includes an insulator layer 232 coated on the opposite core surfaces of the metal core body 2311 and on the peripheral surfaces of the core-winding spokes 2315. Each of the core-winding spokes 2315 further has a distal end face 2317 remote from the sleeve axis (Y) and not covered by the insulator layer 232. The stator coils 234 are wound around the insulator layer 232 at the core-winding spokes 2315. In this embodiment, there are four sets of the stator coils 234. The circuit board 25 is disposed adjacent to one of the opposite core surfaces of the metal core body 2311, and is coupled electrically to the stator coils 234.

The rotor unit 21 includes a drive shaft 216, a sensing ring 212, and a cover member 213. The drive shaft 216 has a base connecting portion 2161 extending into the shaft hole 2720 and mounted rotatably in the shaft tube 272 of the base unit 27 by means of a bearing unit, and a blade connecting portion 2162 extending from the base connecting portion 2161 and disposed outwardly of the shaft tube 272. In this embodiment, the bearing unit includes first and second bearings 273 in the shaft hole 2720. Moreover, in this embodiment, the sensing ring 212 is made of silicon steel, and has an outer ring surface 218, and an opposite inner ring surface 217 that confines a ring hole 215 coaxial with the hole and sleeve axes (X, Y). The ring hole 215 has a size sufficient to receive the stator unit 23 therein such that the inner ring surface 217 of the sensing ring 212 forms an annular clearance with the end faces 2317 of the core-winding spokes 2315. The cover member 213 has a cover plate portion 2131 and a peripheral wall portion 2132 extending from a periphery of the cover plate portion 2131. The peripheral wall portion 2132 is secured to the outer ring surface 218 of the sensing ring 212. The blade connecting portion 2162 of the drive shaft 216 extends fixedly through the cover plate portion 2131, and is a threaded portion in this embodiment.

With further reference to FIG. 4, to assemble the fan motor 2, the stator unit 23 is first sleeved on the shaft tube 272 of the base unit 27. Then, the drive shaft 216 is extended into the shaft tube 272 and is retained rotatably on the same. The blade connecting portion 2162 of the drive shaft 216, which was connected fixedly to the cover member 213 beforehand, is now ready for connection to a fan blade 3. Preferably, the fan blade 3 is configured to engage tightly the cover member 213 in order to enhance engagement between the rotor unit 21 and the fan blade 3.

In use, an electromagnetic field generated at the end faces 2317 of the core-winding spokes 2315 when electric current flows through the stator coils 234 results in a repulsion force that acts upon the inner ring surface 217 of the sensing ring 212, thereby resulting in rotation of the rotor unit 21 and the fan blade 3.

The following are some of the advantages of the fan motor 2 of this invention:

1. During assembly, it is only required to sleeve the stator unit 23 on the shaft tube 272 of the base unit 27, and to extend the drive shaft 216 into the shaft tube 272. As compared to the aforementioned conventional fan motor, assembly of the fan motor 2 of this invention is much easier and simpler to conduct.

Moreover, simultaneous winding of multiple sets of the stator coils 234 of the stator core member 231 can be conducted in a fully automated manner to result in labor and cost savings.

2. In this invention, screw fasteners are not employed to secure the stator unit 23 on the base unit 27. Moreover, the stator unit 23 does not contact the rotor unit 21 to ensure silent operation of the fan motor 2.

3. Since the fan blade 3 is driven directly by the rotor unit 21, and since there is no friction between the stator unit 23 and the rotor unit 21, a maximum torque output can be ensured to result in improved efficiency and power savings.

4. In the present invention, the stator unit 23 is disposed in the rotor unit 21, which in turn is designed for direct connection to the fan blade 3. The construction as such results in a compact design as compared to the aforementioned conventional fan motor.

Moreover, in the manufacture of the fan motor 2 of this invention, the sensing ring 212 and the metal core body 2311 of the stator core member 231 may be punched from a single blank to ensure the presence of an appropriate clearance therebetween.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A fan motor comprising:
a base unit including a base plate that is formed with a central plate hole, and a shaft tube that extends integrally from said base plate at a periphery of said central plate hole and that is formed with a shaft hole defining a hole axis;
a stator unit including
a stator core member having a metal core body that includes a central hub portion and a plurality of core-winding spokes that extend radially, outwardly and integrally from said central hub portion and that are angularly spaced apart from each other, said central hub portion being sleeved on said shaft tube and defining a sleeve axis coaxial with said hole axis, said metal core body having opposite core surfaces along said sleeve axis, each of said core-winding spokes extending in a respective radial direction relative to said sleeve axis and having a peripheral surface that surrounds the respective radial direction, said stator core member further including an insulator layer coated on said opposite core surfaces of said metal core body and on said peripheral surfaces of said core-winding spokes, each of said core-winding spokes further having a distal end face remote from said sleeve axis,
a plurality of stator coils wound around said insulator layer at said core-winding spokes, and
a circuit board disposed adjacent to one of said opposite core surfaces of said metal core body and coupled electrically to said stator coils; and
a rotor unit including
a drive shaft having a base connecting portion extending into said shaft hole and mounted rotatably in said shaft tube of said base unit, and a blade connecting portion extending from said base connecting portion and disposed outwardly of said shaft tube,
a sensing ring having an inner ring surface that confines a ring hole coaxial with said hole and sleeve axes, said ring hole having a size sufficient to receive said stator unit therein such that said inner ring surface of said sensing ring forms an annular clearance with said end faces of said core-winding spokes, and
a cover member having a cover plate portion and a peripheral wall portion extending from a periphery of said cover plate portion, said peripheral wall portion being secured to said sensing ring, said blade connecting portion of said drive shaft extending fixedly through said cover plate portion.

2. The fan motor as claimed in claim 1, wherein said base unit further includes a bearing unit for mounting rotatably said base connecting portion of said drive shaft in said shaft tube.

3. The fan motor as claimed in claim 1, wherein said metal core body includes twelve of said core-winding spokes, and said stator unit includes four sets of said stator coils.

4. The fan motor as claimed in claim 1, wherein at least one of said metal core body and said sensing ring is made of silicon steel.

5. A stator unit of a fan motor, comprising:
a stator core member having a metal core body that includes a central hub portion and a plurality of core-winding spokes that extend radially, outwardly and integrally from said central hub portion and that are angularly spaced apart from each other, said central hub portion defining a sleeve axis, said metal core body having opposite core surfaces along said sleeve axis, each of said core-winding spokes extending in a respective radial direction relative to said sleeve axis and having a peripheral surface that surrounds the respective radial direction, said stator core member further including an insulator layer coated on said opposite core surfaces of said metal core body and on said peripheral surfaces of said core-winding spokes;
a plurality of stator coils wound around said insulator layer at said core-winding spokes; and
a circuit board disposed adjacent to one of said opposite core surfaces of said metal core body and coupled electrically to said stator coils.
